(19) United States
(12) Patent Application Publication
(10) Pub. No.: US 2007/0214123 A1
(43) Pub. Date: Sep. 13, 2007

(54) Method and system for providing a user interface application and presenting information thereon

(75) Inventors: Alan Messer, Los Gatos, CA (US); Anugeetha Kunjithapatham, Sunnyvale, CA (US); Mithun Sheshagiri, Berkeley, CA (US); Phuong Nguyen, San Jose, CA (US); Priyang Rathod, Mountain View, CA (US)

Correspondence Address: Kenneth L. Sherman, Esq.;Myers, Dawes Andras & Sherman, LLP, 11th Floor, 19900 MacArthur Blvd, Irvine, CA, 92612, US

(73) Assignee: Samsung Electronics Co., Ltd., Suwon City (KR)

(21) Appl. No.: 11/713,350

(22) Filed: Mar. 1, 2007

Related U.S. Application Data
(60) Provisional application No. 60/780,398, filed on Mar. 7, 2006.

(51) Int. Cl. G06F 17/30

(52) U.S. Cl. 707/3

(57) ABSTRACT

A presentation system and method provides a GUI application that allows presenting Internet information on electronic devices such as consumer electronic devices with minimal user key presses/commands. The user is enabled to browse/search for Internet information without having to enter queries, using a small number of key presses. Further the user is enabled to obtain desired Internet information with no or minimal user involvement in query construction.

### RELATED APPLICATION

This application claims priority from U.S. Provisional Patent Application Ser. No. 60/780,398 filed on Mar. 7, 2006, incorporated herein by reference.

### FIELD OF THE INVENTION

The present invention relates to providing a user interface for presentation of information to a user, and particularly to providing a user interface application to present information from the Internet to a user.

### BACKGROUND OF THE INVENTION

Browsing web pages on the Internet using a web browser, with the aid of a search engine, has become one of the primary ways of obtaining information. However, information searching, using even the latest existing technologies is still an involved process that requires users to repeatedly enter and modify query keywords using a keyboard.

Users often have to deal with large quantities of information in different formats (such as structured, semi-structured and unstructured) on multiple Internet sources, before locating the required information. Further, it can be quite frustrating when users have to repeatedly modify their query and inspect the numerous search results on devices, such as consumer electronics (CE) devices that do not provide a convenient way of entering/modifying text. As a result, the conventional searching experience is limited to computing devices with a keyboard, such as computers with keyboards (e.g., PCs), and the degree of success in finding the desired information is highly dependent on the user's knowledge and skill in forming a good query, and performing results analysis.

Certain search engines (e.g., Google, Copernic, etc.) work on both enterprise data search (Enterprise Appliance) and personal data search (Personal Desktop Search). Such desktop search approaches are extensions of Internet searching where users can search for content on their PCs. However, such desktop search approaches have shortcomings including requiring users to form queries, requiring users to have knowledge and skill to form/refine their queries in order to obtain desired results, requiring a significant amount of computing resources which far exceed what CE devices (e.g., TV, DVD player, PVR, Set Top Box, etc.) provide, requiring input devices, such as a keyboard to enter significant amounts of text, requiring a powerful PC-type of computing device for a user to inspect a large amount of search results.

Search engines such as Ask and Yahoo provide a way for users to refine their search queries without having to edit their original query. This is achieved by displaying a set of related and expanded search queries on a page displaying the search results (corresponding to the original search query), and allowing the users to change their queries by just clicking on one of the related/expanded queries. While this approach allows the user to modify queries without the use of a keyboard, a “mouse” type of input device is essential to navigate the page and to select the new queries, thereby making it unsuitable for use on CE devices. Further, such a query refinement technique is dependant on a specific search engine provider.

There is, therefore, a need for a method and system that provides a user interface for presentation of information to a user, which addresses the above shortcomings.

### BRIEF SUMMARY OF THE INVENTION

The present invention provides a method and system which implements a graphical user interface (GUI) application that allows for the presentation of information from sources such as the Internet on various electronic devices. An example includes CE devices that do not provide a convenient way of entering/modifying text (e.g., without a traditional keyboard or a mouse).

The present invention further provides techniques that enable users to browse/search for information without having to enter queries. Such techniques include enabling users to utilize a device (e.g., TV) for browsing information with a small number of key presses (input commands). The users are further enabled to obtain desired Internet information with no or minimal user involvement in query construction.

These and other features, aspects and advantages of the present invention will become understood with reference to the following description, appended claims and accompanying figures.

### BRIEF DESCRIPTION OF THE DRAWINGS

FIG. 1 shows a functional block diagram of an example network which implements an embodiment of the present invention.

FIG. 2 shows a flowchart of the steps of a process for providing a user interface (UI) and presenting the desired information to a user, implemented in the network of FIG. 1, according to an embodiment of the present invention.

FIG. 3 shows an example of the user interface of FIG. 2, according to an embodiment of the present invention.

FIG. 4 shows another example of the user interface of FIG. 2, according to an embodiment of the present invention.

FIG. 5 shows an example functional block diagram of a digital television (DTV) 30 that implements the GUI program execution code/firmware, according to an embodiment of the present invention.

FIG. 6 shows a flowchart of the steps of a process for providing the UI in FIGS. 3-4, according to an embodiment of the present invention.

### DETAILED DESCRIPTION OF THE INVENTION

The present invention provides a method and system which implements a graphical user interface (GUI) application that allows presentation of information from sources such as the Internet on various electronic devices. In one embodiment, the present invention provides a GUI application that enables a user to seamlessly browse/search for information available on the Internet using a small number of key presses. The GUI application further enables the user to utilize an electronic device (e.g., a CE device) to access additional information available on the Internet, related to particular information that the user is interested in. Example information (data) types include media content (e.g., audio, video or image files that contain some kind of metadata information, etc.), cable/live TV programs (e.g., containing subtitles, closed-captions and/or an electronic program guide (EPG)), etc.

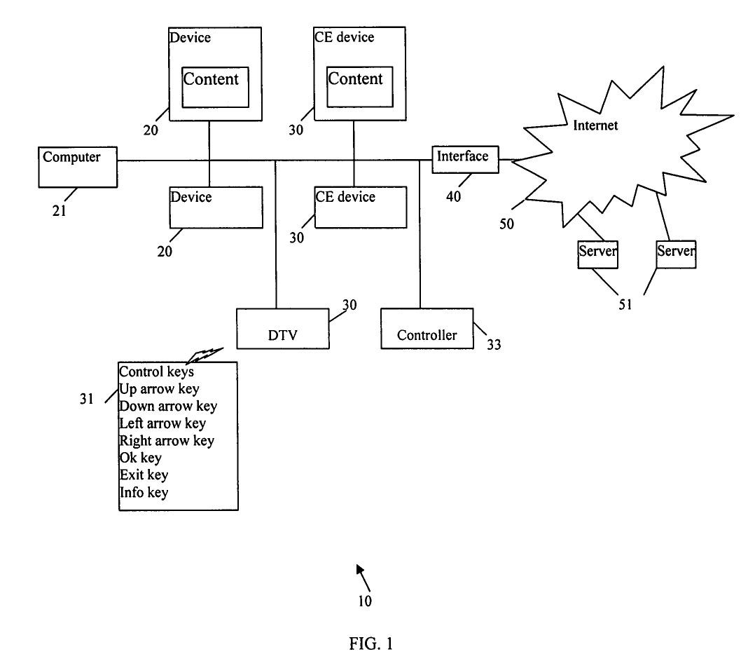

FIG. 1 shows a functional architecture of an example network 10, such as a local area network (LAN) in a home, embodying aspects of the present invention. The network 10 comprises devices 20 which may include content, a PC 21, CE devices 30 which may include content, and an interface 40 that connects the network 10 to an external network 50 (e.g., another local network, the Internet, etc.). The external network 50 can be connected to one or more servers 51. Though the devices 20 and 30 are shown separately, a single physical device can include one or more logical devices.

The devices 20 and 30, respectively, can implement the UPnP protocol for communication therebetween. Though in the example described herein, the UPnP is utilized by the network 10; those skilled in the art will recognize that the present invention is useful with other network communication protocols (e.g., Jini, HAVi, IEEE 1394, etc.).

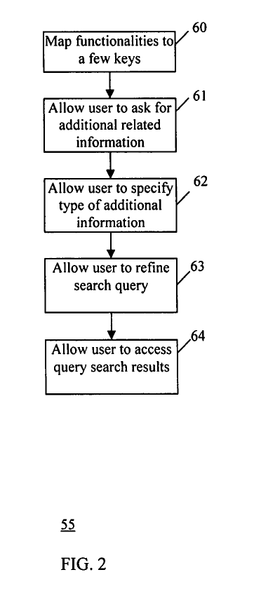

Referring to FIG. 2, an example process 55 that enables the user to obtain desired information from the Internet using a simple and intuitive GUI application, according to the present invention, includes the steps of:
Step 60: Mapping the functionalities that support information search, to a small number of keys (e.g., mapping such functionalities to a few keys of a TV remote control 31 (FIG. 1) as an example for receiving user input when using a DTV 30 for information access).
Step 61: Enabling the user to express interest in obtaining additional information related to information currently accessed by the user (e.g., providing an action button on the remote control 31 for the user to press, and mapping this action into a “more info” request, etc.).
Step 62: Enabling the user to indicate the specific type of additional information the user is looking for, after the user has expressed interest in accessing additional information. An example involves performing a search using a search query, and displaying a set of keywords related to the data that the user has expressed interest in (e.g., a TV program or media content the user is accessing). Then, providing a combination of keys (e.g., up/down/right/left arrow keys) on a remote control 31 for the user to select one of the keywords as a (refined) search query.
Step 63: Enabling the user to refine the search query (i.e., the selected keywords), such as by displaying a set of categories for a keyword selected by the user and providing a combination of the arrow keys (up/down/right/left arrows) on the remote control 31 for the user to select one of the keyword categories. When the user chooses a keyword category, the keyword along with the keyword-category now becomes a keyword. The system supplies keyword categories for the new keyword if desired by the user. The GUI allows the user to refine the search queries as many times as the user desires by just repeating the process described above.
Step 64: Performing a search based on the query formulated from the preceding step. Then enabling the user to access the search results by displaying a list of search results corresponding to the keyword previously selected by the user. Then providing a combination of arrow keys (up/down/right/left arrows) on the remote control device 31 for the user to select one of the refined search results. An example of a search result includes a link to a web page containing information about the search query, wherein the title of the web page is displayed to the user on the GUI.

In an example scenario according to the present invention, the GUI allows a user to access related information for a program that the user is watching on the DTV 30. The GUI is controlled using the remote control device (RC) 31 of the DTV 30. In this example, it is assumed that the TV program that the user is watching provides closed-captions, and that the DTV 30 has no keyboard or mouse.

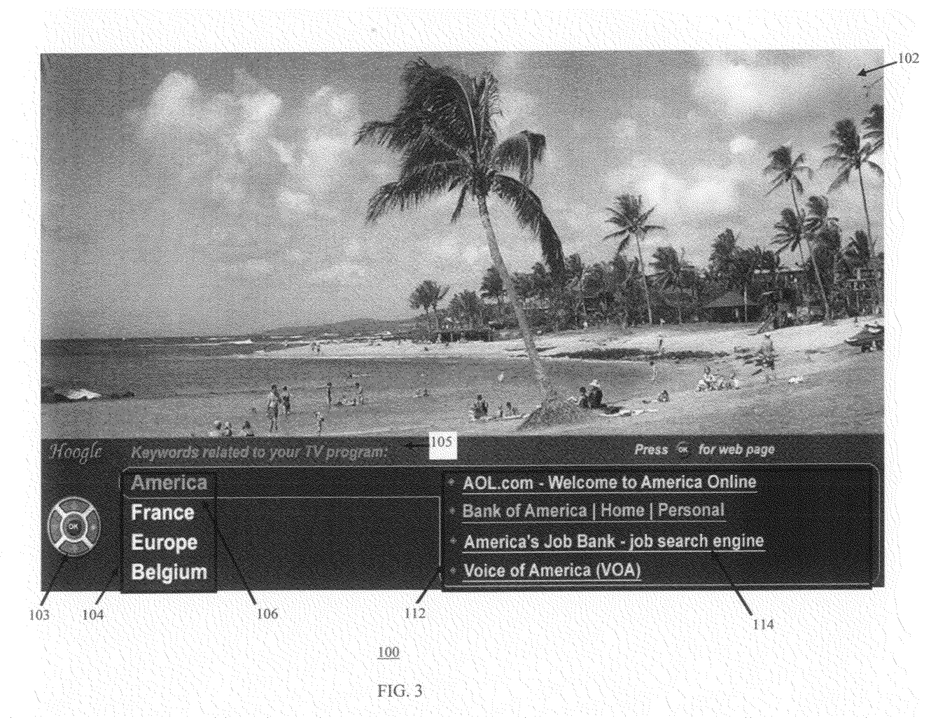

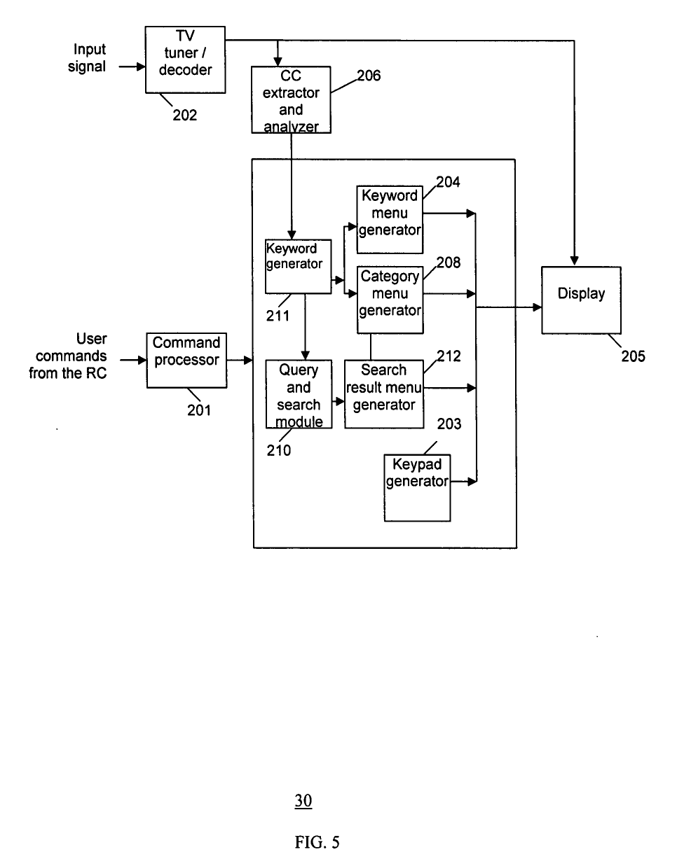

The user is watching a program (e.g., CNN News) on the DTV 30, wherein an example GUI 100 (FIG. 3) according to the present invention, that runs on the DTV 30, which allows the user to access related information for a TV program 102 that the user is watching on the DTV 30. A keyword menu (KM) 104 displays a list of keywords 106 (e.g., America, France, Europe, Belgium, etc.) generated by the keyword generator 211 (FIG. 5) based on the closed-captions from the TV program 102, and allows the user to select a particular keyword 106 and indicate a search query.

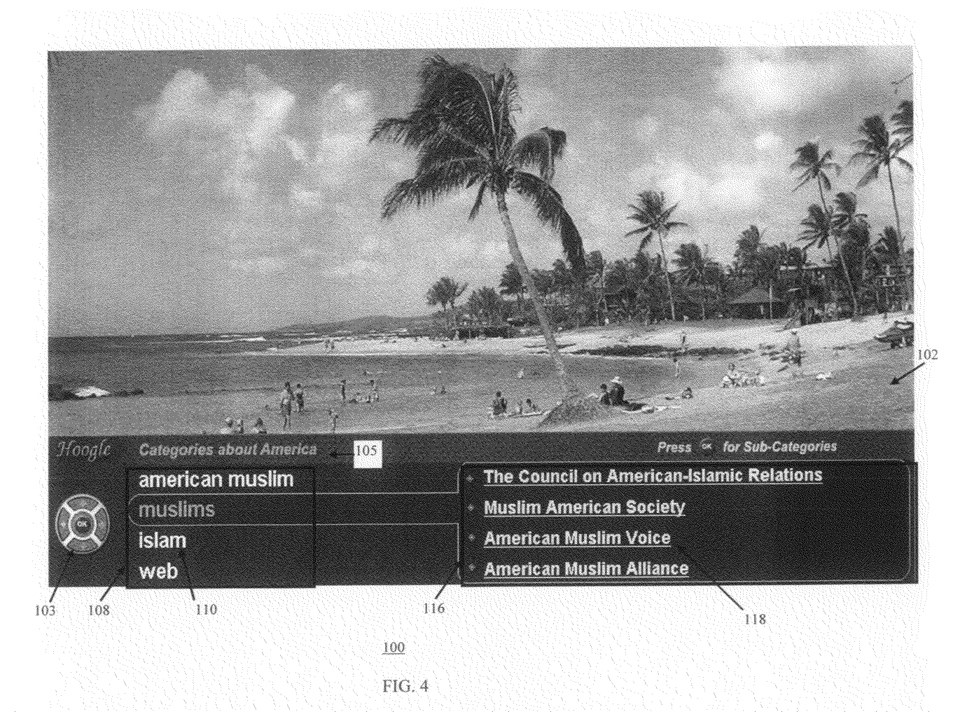

A category menu (CM) 108 (FIG. 4) displays a list of categories 110 (e.g., American Muslim, Muslims, Islam, web, etc.) for a selected keyword 106 and allows the user to select a particular category 110 to further refine the search query. A search results menu 112 (FIG. 3) displays a list of search results 114 corresponding to the search query (keyword) specified by the user and allows the user to select a search result. A search results menu 116 (FIG. 4) displays a list of search results 118 corresponding to the refined search query (keyword+category) specified by the user and allows the user to select a search result.

The GUI program execution code/firmware can be implemented on any device 20, 30 in FIG. 1, (e.g., PC, DTV, mobile phone, etc., capable of executing such program code). The GUI program code can also be implemented on a general controller 33 (FIG. 1) comprising a processor. The controller 33 implements the process of generating and manipulating the keywords, the categories and the search results, etc., as described above. FIG. 5 shows an example functional block diagram of a DTV 30 that implements the GUI application program execution code/firmware, including a command processor 201 that processes user commands from the RC 31, a TV tuner/decoder 202, a keypad generator 203, a keyword menu generator 204, a display 205, a category menu generator 208, and a search result menu generator 212 (described further below).

The command processor 201 implements mapping the functionalities that support information search, to a small number of keys (e.g., mapping such functionalities to a few keys of a TV RC 31 as an example for receiving user input) when using the DTV 30 for information access. Further, a closed-caption (CC) extractor and analyzer 206 captures and extracts closed-captions/subtitles in the incoming video stream in the input signal for the currently viewed program (video stream, TV channel on a selected channel, etc). The input signal can be from a storage device, cable, satellite, or other sources of video information. The text capturing process supports existing captioning standards to capture closed-captions or subtitles from both analog and digital signals. Real-time closed-caption text can be saved continuously in a ring buffer for immediate analysis upon request. Preferably, the ring buffer is refreshed per any context changes, such as a channel change, a program change, etc. The CC extractor and analyzer 206 further accesses the buffered text to extract keywords and phrases related to a user request or interest. For keyword extraction, information of potential interest to the user can be determined by monitoring user interactions with the DTV. Important words and phrases from the closed-captions are identified as keywords. For example, when the user is watching a TV program, it is likely that that the user is interested in the content of the TV program. The content of the TV program is determined by analyzing the text received as closed-captions for that TV program. Further context can be gathered from the information about the channel being watched. Such information can be combined to make recommendations for potential topics of interest to the user.

Further a query and search module 210 forms search queries, and refines queries, for information (e.g., video, etc.) related to the program currently viewed. The queries include keywords and phrases extracted from the currently viewed program. We henceforth will refer to keywords and phrases using the term “keywords”. The query and search module 210 accesses search engines on the Internet to perform the search and acquire results.

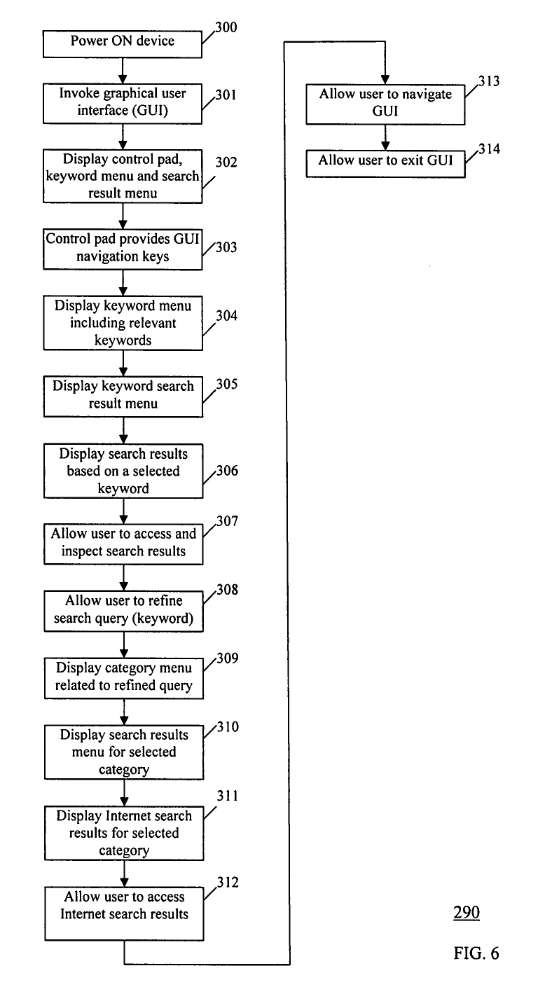

FIG. 6 shows a flowchart of an example process 290 implemented by the DTV 30 in FIG. 5, which enables the user to obtain desired information from the Internet using the GUI 100 as shown in FIGS. 3-4, including the steps of:
Step 300. The user powers on the DTV 30, uses the RC 31 to send commands to the command processor 201 to a channel using the tuner/decoder 202, and starts watching the TV program 102 on the display 205, wherein the TV program 102 includes closed-captions.
Step 301. The user presses an “info” button on the DTV's RC 31 to invoke the GUI 100 for display of information (FIG. 3) on the display 205.
Step 302. The GUI 100 presents on the display 205, a control pad 103 provided by the keypad generator 203, a KM 104 provided by the keyword menu generator 204 and the search result menu 112 (FIG. 3) provided by the search result menu generator 212. A portion 105 of the GUI 100 provides a title “Keywords related to your TV program” and spans horizontally across the bottom part of the TV screen with sufficient room for e.g., five (5) lines of text, which is based on information from the CC analyzer and extractor 206.
Step 303. The control pad 103 is displayed on the very left of the GUI 100 and shows the usable input keys mimicking the arrow keys on the RC 31 that should be used to navigate the GUI 100. All currently usable input keys used for navigation are highlighted. The control pad 103 provides visual feedback to the user as the user presses arrow keys on the RC 31.
Step 304. The KM 104 is displayed to the right of the control pad 103 and shows a vertical column of keywords 106 relevant to the program 102 that the user is watching and has shown interest in obtaining more information about. The most relevant keywords 106 are displayed first in the menu 104. The KM 104, by default, visibly shows e.g. 4-5 keywords 106 and the rest of the keywords available can be viewed by scrolling down the keyword list in the KM 104 using the arrow keys on the RC 31.
Step 305. The search results menu 112 (FIG. 3) is displayed to the right of the KM 104, and shows a vertical column of search results 114 (e.g., title of web pages) relevant to a selected/highlighted keyword 106 (e.g., America).
Step 306. By default, when the GUI 100 starts up, the first entry in the KM 104 is highlighted and the search results menu 112 shows the Internet search results for this highlighted keyword. To access a search result 114 for a highlighted keyword 106, the user can press the right arrow on the RC 31 (or on the control pad 103 in a touch screen implementation that dispenses with the RC 31), to move to the search results menu 112 and then use the up/down arrows on the RC 31 to browse through the search results 114. The user then presses “ok” to access any particular search result 114. When the user selects a particular search result, a web browser pops up displaying the selected “search result” web page (e.g., web links such as “AOL.com—Welcome to America Online” in the search results menu 112 in FIG. 3, pointing to http://www.aol.com internally). When done browsing the web page, the user can simply close the webpage using the “exit” button on the RC 31 and go back to the GUI 100 on the DTV 30.
Step 307. To access the search results 114 for other keywords 106, the user can use the up/down arrows on the RC 31 to change his keyword selection and the search results menu 112 is automatically updated to show the search results 114 for the currently highlighted keyword 106 (an example of accessing a search result was discussed in step 306 above). If the user is currently on the search results menu 112, the user may proceed to the KM 104 first by pressing the “left” arrow key on the RC 31.
Step 308. To further refine the search query (represented as keywords 106 in the GUI 100), the user can highlight the keyword that he wants to either refine or expand and press the “ok” button on the RC 31. The module 210 enables the query refinement and further searching.
Step 309. The CM 108 (FIG. 4) provided by the category menu generator 208, is displayed to the right of the control pad 103 (replacing the KM 104) and shows a vertical column of categories 110 relevant to the keyword 106 that the user has shown interest to refine/broaden. The most relevant categories 110 are displayed on the top of the CM 108. The CM 108, by default, visibly shows only e.g., 4-5 categories 110 and the rest of the categories available can be reached by scrolling down the list of categories 110. The GUI 100 in area 105 is now titled “Categories about ‘X’ ”, wherein ‘X’ would be the keyword selected by the user in step 308.
Step 310. A new search results menu 116 (FIG. 4) provided by the search result menu generator 212, is displayed to the right of the CM 108 (replacing the search results menu 112 (FIG. 3) displayed for the keywords 106). The search results menu 116 shows a vertical column of search results 118 (e.g., title of web pages) relevant to the selected/highlighted category 110 (e.g., Muslims), and the keyword 106 selected earlier.
Step 311. By default, when the CM 108 is shown, the first entry in the CM 108 is highlighted and the search results menu 116 shows the Internet search results for the highlighted category (and the keyword selected earlier). To access a search result 118 for a highlighted category 110, the user can press the right arrow on the RC 31 to move to the search results menu 116 and then use the up/down arrows on the RC 31 to browse through the search results 118 and press the “ok” key on the RC 31 to access any particular search result 118. When the user selects a particular search result 118, a web browser pops up displaying the selected “search result” web page. When done browsing the web page, the user can simply close it using the “exit” button/key on the RC 31 and go back to the GUI 100 on the DTV 30.
Step 312. To access the search results 118 for other categories 110, the user can use the up/down arrows on the RC 31 to change the category selection, wherein the search results menu 116 is automatically updated to show the search results 118 for the currently highlighted category 110 (accessing a search result 118 was discussed immediately above in step 311). If the user is currently on the search results menu 116, the user should go to the CM 108 first by pressing the “left” arrow key on the RC 31.
Step 313. When the user is on the CM 108 and wishes to go back to the KM 104, the user simply has to press the “left” arrow key on the RC 31.
Step 314. The user can use the “exit'” key on the RC 31 to close the GUI 100.

An example operation scenario by a user, John, according to the above steps in conjunction with FIGS. 3-4, is provided below. John is watching a TV news program about Muslim communities living in different countries, such as America, France, etc. John requests more information about the news program by pressing the “info” button on his remote control. The GUI presenting a control pad, a keyword menu and a search result menu is displayed on the DTV (FIG. 3). The keyword menu shows a vertical column of keywords such as “America”, “France”, “Europe”, “Muslim community”, etc. The first keyword “America” is highlighted and the search results corresponding to it are displayed on the right of the keyword menu. The search results menu shows a vertical column of search results (title of web pages) such as “AOL.com—Welcome to America online”, “Bank of America”, etc. John wants to refine his search query (“America”), so he presses the “ok” button while on the keyword “America” to see the categories related to “America”.

In another example, John is interested in the Muslims in America and so selects a Muslim Community keyword. The keyword menu is replaced by a category menu (FIG. 4) that shows a vertical column of categories such as “American Muslim”, “Muslims”, “Islam”, etc. The first category “American Muslim” is by default highlighted and the search results menu displays search results for this category. John presses the down arrow to highlight “Muslims” instead. The search results menu on the right is automatically updated to show some Internet search results for this keyword; the search results displayed are “The Council on American-Islamic Relations”, “Muslim American Society”, “American Muslim Voice”, etc. John uses the “right” arrow key to move to the search results menu and scrolls down using the “down” arrow to select the “Muslim American Society” search result. John presses “ok” on his remote control and the corresponding web page is displayed on a web browser. John enjoys reading the web page as he got the desired information and presses the “exit” button on his remote control to go back to the GUI. John presses the “exit” button again on the remote control to close the GUI and continues watching the news program.

Although the above example implementation utilizes a DTV, the present invention enables users to use various electronic devices, such as CE devices (e.g., TV, mobile phones, PDAs, PCs, etc.), for searching information using a small number of keys without a keyboard and mouse. The present invention further enables users to obtain desired Internet information with no or minimal involvement of query construction. As those skilled in the art will recognize, other ways of displaying information according to the principles of the present invention are possible. For example, the information displayed in FIGS. 3-4 can be displayed on a different part of the TV screen, or distributed across the screen in different areas.

The abovementioned conventional techniques for query refinement dependant on a specific search engine provider. The present invention provides query refinement that operates with all search engines that provide snippets (short accompanying piece of text with each search result). Snippets are provided by a majority of the search engines and which the present invention utilizes for better coverage.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of presenting information to a user, comprising the steps of:
utilizing an electronic device connected to a network for searching desired information on the network using a small number of input commands;
obtaining additional relevant information with minimal user involvement in query construction; and
presenting the information on a graphical user interface (GUI).

2. The method of claim 1 wherein the network comprises the Internet.

3. The method of claim 1 wherein the network comprises a local network and an external network, wherein the electronic device is connected to the local network.

4. The method of claim 1 wherein the electronic device comprises a consumer electronic device.

5. The method of claim 1 wherein the step of obtaining additional relevant information further includes the step of:
accessing additional information available on the network, related to particular information that the user desires.

6. The method of claim 1 further including the step of:
mapping functionalities for information search to a small number of input commands to the electronic device; and
wherein searching desired information on the network using a small number of input commands, further includes utilizing the device to access desired information on the network based on said input commands from a user.

7. The method of claim 1 further including the step of:
mapping functionalities for information search to a small number of input commands to the electronic device; and
wherein obtaining additional information further includes receiving a user input command expressing interest in obtaining additional information related to the desired information currently accessed by the user.

8. The method of claim 7 wherein obtaining additional information further includes receiving user input command indicating further searching for the type of additional information.

9. The method of claim 8 further including receiving further user input commands refining the search for the type of additional information.

10. The method of claim 8 wherein receiving user input commands indicating the type of additional information includes:
displaying a set of keywords related to the desired information; and
providing a set of one or more input commands for the user to select one or more of the keywords indicating the type of additional information, and receiving the user's input.

11. The method of claim 10 further including receiving further user input commands refining the search for the type of additional information.

12. The method of claim 11 wherein receiving further user input commands refining the search includes:
receiving further user input commands refining a selected keyword by displaying a set of keyword categories for the selected keyword; and
providing a set of one or more input commands for the user to select one or more of the keyword categories further indicating the type of additional information.

13. The method of claim 12 further including the steps of:
obtaining search results from the network based on the selected keyword categories;
providing access to the search results by displaying a list of search results corresponding to the previously selected keyword and/or keyword category; and
providing a set of one or more input commands for the user to select one or more of the search results.

14. The method of claim 13 wherein the search results include links to web pages containing information about the search.

15. The method of claim 13 further including the steps of:
receiving a user input command to display content of one of the web pages; and
displaying the content of the web page on a GUI.

16. The method of claim 7 wherein the network comprises a local network and an external network, wherein the electronic device is connected to the local network.

17. The method of claim 7 wherein the electronic device comprises a consumer electronic device.

18. The method of claim 16 wherein the step of obtaining additional relevant information further includes the step of:
accessing additional information available on the external network, related to particular information that the user desires.

19. The method of claim 18 wherein:
the external network comprises the Internet; and
the local network comprises a local area network.

20. The method of claim 7 wherein mapping functionalities includes mapping functionalities for information search to a small number of input key presses representing said input commands.

21. A system for presenting information to a user, comprising:
an application module configured to search desired information on a network using a small number of user input commands;
a search module configured to obtain additional relevant information with minimal user involvement in query construction; and
a presentation module configured to present the information on a graphical user interface (GUI).

22. The system of claim 21 wherein:
the application module comprises an extractor that is configured to receive a video input signal including a video stream and to obtain content information corresponding to the video stream, and a keyword generator that is configured to extract keywords relating to information of interest to the user from the content information;
the search module comprises a query module that is configured to construct a query based on the keywords using a small number of input commands with minimal user involvement, and to access a resource for searching relevant information on the network based on the query; and
the presentation module is further configured to present the information on the GUI and provide user refinement of the query.

23. The system of claim 22 wherein the network comprises a local network and an external network, wherein the resource is located in the external network.

24. The system of claim 21 wherein the external network comprises the Internet.

25. The system of claim 22 wherein the search module is further configured to access additional information available on the network, related to particular information that the user desires.

26. The system of claim 25 wherein the presentation module further includes:
a command processor configured to map functionalities for information search to a small number of input commands; and
wherein the search module is further configured to access desired information on the network based on said input commands from a user.

27. The system of claim 25 wherein the presentation module further includes a keyword menu generator that is configured to receive a user input command selecting one or more keywords expressing interest in obtaining additional information related to the desired information currently accessed by the user.

28. The system of claim 27 wherein the presentation module further includes a category menu generator that is configured to receive a user input command indicating further searching for the type of additional information.

29. The system of claim 28 wherein the presentation unit further includes a search result menu generator for displaying search results to the user.

30. The system of claim 29 wherein the keyword menu generator is further configured to receive further user input commands refining the search for the type of additional information.

31. The system of claim 28 wherein the keyword menu generator is further configured to display a set of keywords related to the desired information, and provide a set of one or more input commands for the user to select one or more of the keywords indicating the type of additional information, and receiving user input.

32. The system of claim 29 wherein the keyword menu generator is further configured to receive further user input commands refining a selected keyword by displaying a set of keyword categories for the selected keyword, and to provide a set of one or more input commands for the user to select one or more of the keyword categories further indicating the type of additional information.

33. The system of claim 32 wherein the presentation module is further configured to provide access to the search results by displaying a list of search results corresponding to the previously selected keyword and/or keyword category, and to provide a set of one or more input commands for the user to select one or more of the search results.

34. The system of claim 33 wherein the search results include links to web pages containing information about the search.

35. The system of claim 33 wherein the search result menu generator is further configured to receive a user input command to display content of one of the web pages, and display the content of the web page on a GUI.

36. The system of claim 27 wherein the network comprises a local network and an external network, wherein the electronic device is connected to the local network.

37. An electronic device for presenting information to a user, comprising:
an application module configured to search desired information on a network using a small number of user input commands;
a search module configured to obtain additional relevant information with minimal user involvement in query construction; and
a presentation module configured to present the information on a graphical user interface (GUI).

38. The device of claim 37 wherein:
the application module comprises an extractor that is configured to receive a video input signal including a video stream and to obtain content information corresponding to the video stream, and a keyword generator that is configured to extract keywords relating to information of interest to the user from the content information;
the search module comprises a query module that is configured to construct a query based on the keywords using a small number of input commands with minimal user involvement, and to access a resource for searching relevant information on the network based on the query; and
the presentation module is further configured to present the information on the GUI and to provide user refinement of the query.

39. The device of claim 38 wherein the network comprises a local network and an external network, wherein the resource is located in the external network.

40. The device of claim 37 wherein the external network comprises the Internet.

41. The device of claim 38 wherein the search module is further configured to access additional information available on the network, related to particular information that the user desires.

42. The device of claim 41 wherein the presentation module further includes:
a command processor configured to map functionalities for information search to a small number of input commands; and
wherein the search module is further configured to access desired information on the network based on said input commands from a user.

43. The device of claim 41 wherein the presentation module further includes a keyword menu generator that is configured to receive a user input command selecting one or more keywords expressing interest in obtaining additional information related to the desired information currently accessed by the user.

44. The device of claim 43 wherein the presentation module further includes a category menu generator that is configured to receive a user input command indicating further searching for the type of additional information.

45. The device of claim 44 wherein the presentation unit further includes a search result menu generator for displaying search results to the user.

46. The device of claim 45 wherein the keyword menu generator is further configured to receive further user input commands refining the search for the type of additional information.

47. The device of claim 44 wherein the keyword menu generator is further configured to display a set of keywords related to the desired information, and to provide a set of one or more input commands for the user to select one or more of the keywords indicating the type of additional information, and receiving user input.

48. The device of claim 45 wherein the keyword menu generator is further configured to receive further user input commands refining a selected keyword by displaying a set of keyword categories for the selected keyword, and to provide a set of one or more input commands for the user to select one or more of the keyword categories further indicating the type of additional information.

49. The device of claim 48 wherein the presentation module is further configured to provide access to the search results by displaying a list of search results corresponding to the previously selected keyword and/or keyword category, and to provide a set of one or more input commands for the user to select one or more of the search results.

50. The device of claim 49 wherein the search results include links to web pages containing information about the search.

51. The device of claim 49 wherein the search result menu generator is further configured to receive a user input command to display content of one of the web pages, and display the content of the web page on a GUI.

52. The device of claim 43 wherein the network comprises a local network and an external network, wherein the electronic device is connected to the local network.

53. The device of claim 43 wherein the device comprises a consumer electronic device.
